(19) United States
(12) Patent Application Publication
(10) Pub. No.: US 2026/0073531 A1
(43) Pub. Date: Mar. 12, 2026

(54) PARTICLE TRACKING METHOD FOR BROKEN CORAL SOIL BASED ON MULTIMODAL MODEL

(71) Applicant: Zhejiang University of Technology, Hangzhou (CN)

(72) Inventors: Zili HE, Hangzhou (CN); Honglei SUN, Hangzhou (CN); Mengfen SHEN, Hangzhou (CN); Xiaodong PAN, Hangzhou (CN); Kun PAN, Hangzhou (CN); Junda ZHOU, Hangzhou (CN); Yuanqiang CAI, Hangzhou (CN)

(73) Assignee: Zhejiang University of Technology, Hangzhou (CN)

(21) Appl. No.: 19/393,546

(22) Filed: Nov. 18, 2025

(30) Foreign Application Priority Data
Sep. 25, 2025 (CN) 202511390384.7

(51) Int. Cl. G06T 7/20; G06T 3/4007; G06T 7/10; G06T 7/80; G06T 15/00; G06V 10/77

(52) U.S. Cl. CPC G06T 7/20; G06T 3/4007; G06T 7/10; G06T 7/80; G06T 15/00; G06V 10/7715; G06T 2207/30241

(57) ABSTRACT

The present disclosure belongs to the field of particle tracking technology of coral particles in soil, and specifically discloses a particle tracking method for coral particles in soil based on a multimodal model. The method comprises a particle tracking method that enables counting the coral soil particles in an image by using an improved small sample counting model. Coral soil particles in the figures are segmented, and contour coordinates and morphological characteristics of coral soil particles are obtained. Multiple images are put into an optimized BoT-SORT algorithm, and a three-dimensional motion trajectory of the surface coral soil particles is obtained during the test. This method allows for comprehensive observation throughout a triaxial test, and it not only increases the speed and accuracy of coral soil particle segmentation and reduces the tracking error rate, but also improves overall precision.

### TECHNICAL FIELD

The present disclosure relates to the field of particle tracking technology of coral particles in soil, especially a particle tracking method for coral particles in soil based on a multimodal model.

### BACKGROUND

Coral soil is a type of soil derived from coral reefs, typically found in tropical marine environments, especially in islands and coastal regions with well-developed coral ecosystems. Due to the porous structure and composition of coral soil particles, they are prone to breakage under external forces. This may lead to alterations in the particle structure, thereby influencing the soil's bearing characteristics and shear strength.

The triaxial test is a commonly used method in soil mechanics for investigating the stress-strain behavior of soil under various loading conditions. This test provides key parameters such as shear strength and deformation modulus, and helps characterize mechanical behaviors, including the stress-strain relationship, stress path, volume change, permeability, and pore pressure evolution. These insights are essential for establishing constitutive models and supporting engineering design and applications. However, due to limitations in the materials used in triaxial testing, the particle-scale behavior of coral soil cannot be directly observed. As a result, the particle breakage process during testing remains unclear, resulting in an insufficient understanding of the breakage mechanisms and an incomplete investigation into the physical and mechanical properties of coral soil.

Computer vision is widely employed in geotechnical engineering research. Techniques such as particle image velocimetry (PIV) and particle tracking velocimetry (PTV) are used to measure and track soil particles. However, PIV calculates overall displacement within a region and cannot track individual particles, while PTV is unable to detect particle fragmentation. Therefore, there is an urgent need to develop a particle tracking method suitable for small-sized coral soil that can account for particle breakage.

### SUMMARY

The purpose of this invention is to provide a particle tracking method for coral particles in soil based on a multimodal model. This method allows for comprehensive observation throughout the triaxial test, it not only increases the speed and accuracy of coral soil particle segmentation and reduces the tracking error rate, but also improves overall precision. Moreover, it achieves zero-sample recognition, thereby removing the requirement for any specialized model training.

In order to achieve the above purpose, the invention provides a particle tracking method for coral particles in soil based on a multimodal model, including the following steps:
S1. Triaxial test using a transparent rubber triaxial membrane;
S2. Shooting a shearing process of coral soil particles in real time by two cameras and saving the images taken;
S3. Obtaining a three-dimensional cloud image of surface particles by three-dimensional reconstruction of the images taken in S2 through a binocular vision algorithm;
S4. Expanding a side of the triaxial specimen taken in S2 into a plane by a bilinear interpolation method;
S5. Improving a small sample counting model;
S6. Counting the coral soil particles in the image by using the improved small sample counting model, and outputting the position of each target;
S7. Inputting the image in S6 into a segmentation model, segmenting the coral soil particles, and obtaining a segmentation result of the coral soil particles;
S8. According to the segmentation results of coral soil particles in S7, obtaining contour coordinates of the coral soil particles, and calculating an aspect ratio, convexity, sphericity, roundness, and Feret diameter of coral soil particles according to the contour coordinates;
S9. Inputting multiple images processed in S4 into an optimized BoT-SORT algorithm, and then performing multi-target tracking, and adding a crushing matching mechanism in multi-target tracking process.
S10. Inputting the tracking results in S9 into the three-dimensional cloud map of S3, and obtaining the three-dimensional motion trajectory of the surface coral soil particles during the test.

In some embodiments, in S3, the binocular vision algorithm is divided into four steps: camera calibration, image correction, feature matching, disparity smoothing, and post-processing.

In some embodiments, the camera calibration obtains internal parameters of each camera and external parameters between the cameras through Zhang's calibration method, and converts the image coordinates to a same scale and reference frame to ensure an accuracy of subsequent matching calculations; image correction is to project two images onto a plane so that the corresponding points of each scene point overlap on a horizontal line; feature matching uses a global matching algorithm to match corresponding pixels of the physical scene points in left and right images, and performs a disparity estimation; disparity smoothing and post-processing uses filtering and smoothing algorithms for post-processing to solve a problem of noise and discontinuity in disparity maps and improve a continuity and edge retention of disparity maps.

In some embodiments, in S4, the bilinear interpolation method is based on information of four nearest pixels to be estimated, namely, the pixels in the upper left, the upper right, the lower left, and the lower right positions; a weighted average is performed according to relative distances between pixels and the target point, thereby achieving a smooth transition that converts the captured surface information into planar data.

In some embodiments, in S5, the improvement of the small sample counting model is to introduce a self-attention mechanism and a feature enhancement module into the model to enhance a mutual relationship between different spatial locations.

In some embodiments, in S6, a position of each target refers to a center point coordinate of each coral soil particle.

In some embodiments, in S7, the segmentation model uses Segment Anything Model (SAM); the center point coordinates of the coral soil particles are used as point prompt, and the “coral soil particles” are input into the segmentation model as text prompt to segment the image, the segmentation result of the coral soil particles refers to the contour coordinates of the coral soil particles.

In some embodiments, in S9, BoT-SORT optimization refers to adding convexity, sphericity, roundness, and Feret diameter to the Kalman filter of BoT-SORT.

In some embodiments, in S9, the crushing matching mechanism refers to using Harris corner detection to extract the feature points in the image, and then matching the feature points through Fast Library for Approximate Nearest Neighbors (FLANN) to realize a crushing matching between the original particles and the broken particles; after the matching between the original particles and the broken particles, the broken particles will inherit the identity of the original particles, and add a dimension based on an original identity, the identity of the broken particles will increase by one dimension, thus achieving the purpose of traceability.

In some embodiments, in S10, displacement and breakage of coral soil particles are obtained by combining the two-dimensional plane tracking information with the particle information in the three-dimensional cloud image.

The present disclosure adopts the advantages and beneficial effects of the above-mentioned particle tracking method for coral particles in soil based on a multimodal model:
1. The transparent rubber mold used in the present disclosure is similar to the mechanical properties of ordinary latex film, and can realize real-time monitoring during the test. The present disclosure optimizes the SAFECount model and improves the counting accuracy of the model for the target under dense conditions.
2. The present disclosure combines the counting model with the segmentation model to achieve accurate segmentation at high density, and improves the tracking accuracy of coral soil particles by improving the Kalman filter in BoT-SORT.
3. The counting and segmentation models used in this present disclosure are all “zero sample” models, which have been pre-trained without applying the models to different tasks and new images, making the application of the models on different tasks and new images very efficient.

The following is a further detailed description of the technical scheme of the present disclosure through drawings and implementation examples.

### BRIEF DESCRIPTION OF THE DRAWINGS

FIG. 1 is a flow chart of the particle tracking method for coral particles in soil based on a multimodal model.

FIG. 2 is a curved surface flattening diagram of the coral soil particle breakage tracking method based on the multimodal model, where A is a curved surface diagram of the selected area of the transparent film surface, and B is a planar graph of the selected area in A.

FIG. 3 shows the matching results of different broken particles in a particle tracking method for coral particles in soil based on a multimodal model, where (a) is a matching result before and after the first particle breakage, (b) is a matching result before and after the second particle breakage, (c) is a matching result before and after the third particle breakage, and (d) is a matching result before and after the fourth particle breakage.

### DETAILED DESCRIPTION OF THE EMBODIMENTS

The following is a further explanation of the technical scheme of the present disclosure through drawings and implementation examples.

Unless otherwise defined, the technical terms or scientific terms used in the present disclosure should be understood by people with general skills in the field to which the present disclosure belongs.

Unless otherwise defined, the equipment used in the present disclosure may be purchased from the conventional market.

### Example 1

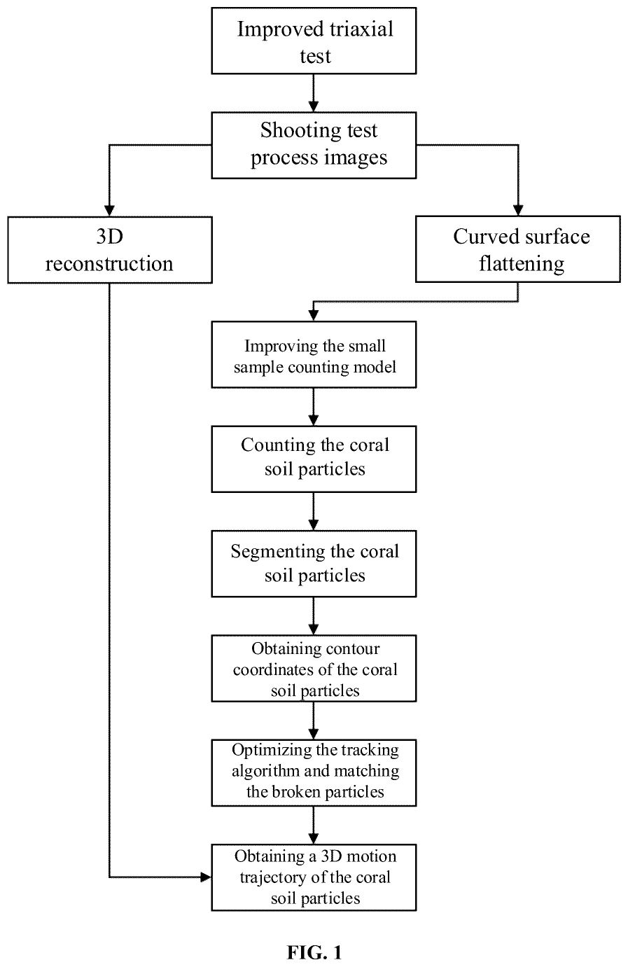

A particle tracking method for coral particles in soil based on a multimodal model, as shown in FIG. 1, includes the following steps:
S1. A transparent rubber triaxial film is used instead of traditional latex film for triaxial test, the mechanical properties of transparent rubber film are similar to those of traditional latex film, which will not have an additional impact on the mechanical properties of coral soil particles during the test.
S2. When shooting binocular vision images, it is required to pay attention to the synchronization of the two cameras, the calibration accuracy, the reasonable selection of the baseline distance, the stable installation method, and the appropriate lighting conditions.

The CMOS high-speed camera is used to shoot the coral soil particles, the frame rate is 0.2 fps, and the image resolution is 5496×3672 pixels.

The synchronization of the camera refers to ensuring that the images taken at the same time reflect the same scene, so as to avoid affecting the accuracy of depth estimation.

The calibration accuracy mainly refers to whether the internal parameters of the camera (focal length, principal point position, lens distortion coefficient) and the external parameters between the camera and the scene (the rotation matrix and translation vector of the camera) are accurate. Calibration accuracy improves as the reprojection error decreases, which is inversely proportional to the accuracy of the parameters.

The baseline distance, defined as the physical separation between the optical centers of the two cameras, is a critical parameter in binocular vision systems as it directly influences the accuracy of depth estimation and 3D reconstruction. A longer baseline increases the disparity of objects between the left and right images, which enhances the ability to distinguish between different depths during disparity calculation. Conversely, an excessively long baseline reduces the overlapping field of view between the cameras, potentially leading to occlusions where a scene is visible to one camera but not the other. Therefore, an optimal baseline must ensure a sufficient overlap between the two images to facilitate accurate correspondence matching. An overly large baseline complicates this matching process, particularly in regions with limited texture.
S3. Three-dimensional cloud images of surface particles are obtained by three-dimensional reconstruction of the images taken in S2 through the binocular vision algorithm.

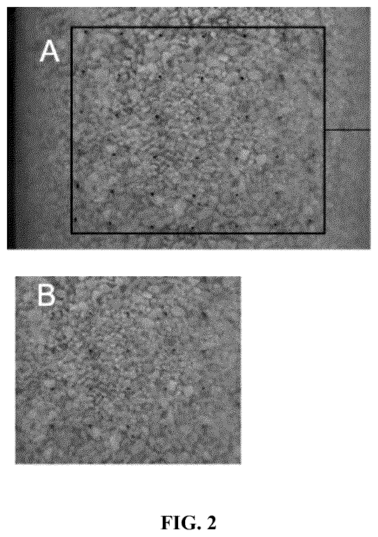

The binocular vision algorithm is used to obtain the disparity map from the two images, and then the disparity is converted into depth information according to the internal and external parameters of the camera. Finally, the depth information is matched with the image coordinates to generate a three-dimensional point cloud.
S4. The bilinear interpolation method is used to expand the side of the cylindrical three-axis pattern taken in S2 into a plane, as shown in FIG. 2. There are pre-marked mark points on the surface of the transparent film, and the spacing between each adjacent mark point is 5 mm. Since the side of the pattern is a curved surface, the spacing between the two points in the pixel picture is not the same.

The image interpolation method is used to estimate the value of any position by knowing the value of discrete sampling points in two-dimensional grids (such as an image pixel matrix).

The basic principle of the bilinear interpolation method is: in the two-dimensional image grid, by using the four nearest known pixel values around the target pixel point, the weight is calculated according to the distance between the target point and the four neighborhood pixels, and then the pixel value of the target point is estimated by the weighted average of these weights. Its mathematical formula (1) is:

$$f ( x , y ) = ( 1 - a ) ( 1 - b ) f ( i , j ) + a ( 1 - b ) f ( i + 1 , j ) + ( 1 - a ) bf ( i , j + 1 ) + a b f ( i + 1 , j + 1 ) ; \qquad ( 1 )$$

where, i=[x] and j=[y] denotes the pixel coordinates of the upper left neighbor of the target point (x,y), a=x−i and b=y−j are the decimal parts of the horizontal and vertical directions of the target point, respectively.
S5. Self-attention mechanism and multi-scale feature fusion are introduced to improve the Similarity-Aware Feature Enhancement block for object Counting (SAFECount).

In the SCM module of SAFECount, a self-attention network is incorporated after the 1×1 convolutional projection to globally integrate information from the projected features. This process outputs an updated query and support features. Meanwhile, within the FEM module, a dedicated fusion block is designed. This block first computes self-attention weights, then fuses the support and query features, and finally produces enhanced features through a convolutional layer followed by a normalization layer.

Multi-scale features are utilized in both the Similarity Comparison Module (SCM) and the Feature Enhancement Module (FEM). By extracting and performing similarity matching at different scales, the model enhances its ability to perceive objects of varying sizes. A multi-scale disparity map generation strategy is also adopted, where disparity is computed at multiple resolutions and then fused to obtain more accurate depth estimation and object counting.

The integration of the self-attention mechanism with multi-scale feature fusion significantly boosts the performance of SAFECount in dense object counting. Multi-scale feature fusion enables the model to handle objects of different sizes simultaneously, capturing finer details while preserving a global semantic understanding. The self-attention mechanism strengthens the model's capacity to capture global dependencies and contextual information by calculating pairwise similarities between pixels. The synergy of these two components allows SAFECount to better handle complex scenes, improving both counting accuracy and overall robustness.
S6. The improved small sample counting model is used to count the coral soil particles in the image, and output the coordinates of each target center point.

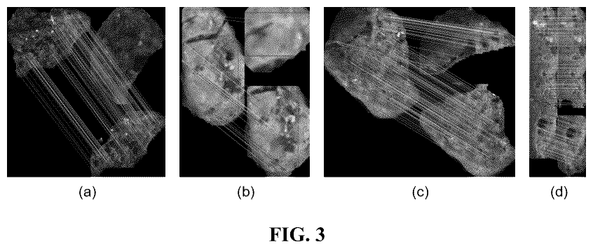

Before counting the coral soil particles in the image, the image is cut into four parts, and the cut-out image is counted, and then the original image is spliced, which can greatly improve the recognition accuracy of the model for the image. The resolution of the original image is 5496×3672 pixel, and the resolution of the cut image is 2948×2036 pixel, the resolution of each image is half of the resolution of the original image plus 200 pixel, after recognition by the counting model, only 2748×1836 pixel is taken as the effective coordinate data, because the complete coral soil particles will be cut into multiple particles during the cutting process, the particles on the cutting line will be counted repeatedly during the counting process. Therefore, it is necessary to expand the cutting image by 200 pixels and take the information within the original size.
S7. The attention points in the attention map in S6 are taken as point prompt, and the text is input into the segmentation model as text prompt to segment the coral soil particles, and the segmentation results of coral soil particles are obtained, as shown in FIG. 3, which are the matching results of different broken particles, where (a) is a matching result before and after the first particle breakage, (b) is a matching result before and after the second particle breakage, (c) is a matching result before and after the third particle breakage, and (d) is a matching result before and after the fourth particle breakage. FLANN is used to match the feature points of different coral soil particles before and after crushing, so as to achieve the purpose of crushing matching between parent particles and sub-particles.

SAM is a multimodal model, and the particle segmentation model has higher accuracy by simultaneously inputting prompts of different dimensions.
S8. According to the segmentation results of the coral soil particles in S7, the contour coordinates of coral soil particles are obtained, and the aspect ratio, convexity, sphericity, roundness, and Feret diameter of coral soil particles are calculated according to the contour coordinates.

The aspect ratio is usually used to describe the shape of the object, which denotes the ratio of the width to the height of the object. Its calculation formula (2) is as follows:

$$Aspect Ratio = \frac{W}{H} ; \qquad ( 2 )$$

where W is the width of the object, and H is the height of the object.

Convexity is the measure of the smoothness of an object's shape. The value of convexity is usually between 1 and 0, and the closer to 1 means that the object is closer to convexity. Its calculation formula (3) is as follows:

$$Conbexity = \frac{{P}_{o b j e c t}}{{P}_{c o nvex hull}} ; \qquad ( 3 )$$

where P_{object} is the actual circumference of the object, P_{convex hull} is the circumference of the convex hull of the object.

Sphericity is used to quantify the degree of sphericity of an object. The sphericity of 1 indicates that the object is completely spherical, and the closer the value is to 1, the closer the object is to the sphere. Its calculation formula (4) is as follows:

$$Sphericity = \frac{{{π}^{1 / 3} ( 6 v )}^{2 / 3}}{A} ; \qquad ( 6 v )$$

Where V is the volume of the object, and A is the surface area of the object. This formula measures the relationship between the smoothness of the surface and the volume of the object, as the value approaches 1, the object more closely approximates a perfect sphere

Roundness is used to measure the degree to which the shape of the object is close to a circle. As the value approaches 1, the object more closely approximates a perfect circle. Its calculation formula (5) is as follows:

$$Circularity = \frac{4 π \cdot Area}{{P}^{2}} ; \qquad ( 5 )$$

where Area is the area of the object; P is the circumference of the object. The roundness value of a circle is 1, and the roundness value of a non-circular object is usually less than 1.

Specifically, the Feret diameter is the minimum diameter of the object, which can also be understood as a minimum projection length of the object.

$${D}_{F} = \frac{{P}_{o b j e c t}}{π} ; \qquad ( 6 )$$

where P_{object} is the circumference of the object. The Feret diameter is calculated by the circumference of the object, which is used to represent the minimum size of the object. The minimum Feret diameter is used to represent the particle size.

Morphological parameters such as aspect ratio, convexity, sphericity, roundness, and Feret diameter are mainly used to describe and quantify the shape and geometric characteristics of objects, and can further describe the crushing form of particles.
S9. The multiple images processed by S4 are input into the optimized BoT-SORT algorithm, and then multi-target tracking is performed, and a broken matching mechanism is added to the multiple object tracking process.

BoT-SORT first predicts and updates the position of the target through the Kalman filter, and then matches the detected target with the existing tracking target through the Hungarian algorithm.

The optimization of the Kalman filter refers to the conversion of the original 8-dimensional Kalman filter in BoT-SORT to a 13-dimensional Kalman filter. The calculation formula (7) is as follows:

$$x = [ {x}_{c} ( k ) , {y}_{c} ( k ) , w ( k ) , h ( k ) , A ( k ) , \\ {C}_{o} ( k ) , S ( k ) , {C}_{i} ( k ) , {D}_{F} ( k ) , {\dot{x}}_{c} ( k ) , {\dot{y}}_{c} ( k ) , \dot{w} ( k ) , \dot{h} ( k ) ] ; \qquad ( 7 )$$

where x_{c} denotes the abscissa of the center point of the object; y_{c} denotes the ordinate of the center point; w denotes the width of the object; h denotes the height of the object; A denotes the aspect ratio of the particles; Cₒ denotes the convexity of the particles; S denotes the sphericity of the object; Cᵢ denotes particle; D_{F} denotes the minimum Feret diameter.

The fragment matching mechanism involves the extraction of feature points within an image utilizing Harris corner detection, followed by the matching of these feature points through the Fast Library for Approximate Nearest Neighbors (FLANN). This process achieves the fragment matching between original particles and broken particles.

Upon successful matching between an original particle and its broken fragments, the broken particles inherit the identity (ID) of the original particle. To facilitate traceability, a new dimension is appended to the inherited ID, thereby extending the identifier for each broken particle.

The segmentation results from each frame are analyzed to obtain the apparent characteristics of individual coral soil particles. By extracting and matching the surface features of particles between the current and the preceding frame, particle breakage can be detected. A successful match between particles assigned different IDs across two frames indicates that a breakage event has occurred. Once breakage is detected, the resulting fragments inherit the ID of the original pre-breakage particle, with an additional dimension appended to its ID. This mechanism supports subsequent analysis of the particle's breakage pattern.

The principle of Harris corner detection is grounded in the analysis of local gradient information within an image. It evaluates whether a point qualifies as a corner by computing the structural tensor of the surrounding area for each pixel. This process begins with the calculation of the image's gradients in both the horizontal and vertical directions, which are then used to construct a gradient-containing matrix known as the structure tensor. A corner response function is subsequently employed to quantify the degree of intensity change at the point. A high response value indicates significant intensity variations in both directions within the local area, leading to the classification of the point as a corner. Harris corner detection is widely applied in fields such as image matching, object recognition, and target tracking due to its capability to accurately extract key feature points from images.

Following feature point extraction, FLANN is employed for feature matching. This step entails extracting feature points from the image and computing their corresponding descriptors. FLANN then performs matching between feature descriptors using efficient nearest-neighbor search algorithms to identify the descriptor most similar to any given query point. By leveraging tree-based structures (such as KD-trees or randomized trees), FLANN accelerates the search process, enabling the rapid identification of the closest matching points within large-scale datasets. Finally, the matching results can be further refined through filtering techniques (e.g., employing the RANSAC algorithm to eliminate outlier matches), thereby enhancing matching accuracy and ensuring the reliability of the matched point pairs.
S10. The tracking results in S9 are input into the three-dimensional cloud diagram of S3, and the three-dimensional motion trajectory of the surface coral soil particles is obtained during the test. The displacement and fragmentation of coral soil particles are obtained by combining the two-dimensional plane tracking information with the particle galaxy in the three-dimensional cloud image.

The tracking pixel results of each frame are converted into the point position in the three-dimensional space, so as to obtain the three-dimensional motion trajectory of each particle and its rotation angle.

Therefore, the present disclosure adopts the above-mentioned particle tracking method for coral particles in soil based on a multimodal model. This method enables comprehensive, full-process observation of triaxial tests, significantly enhances the speed and accuracy of coral soil particle segmentation while reducing tracking errors. Furthermore, its superior generalization capability allows for zero-shot recognition without the need for specialized model training.

Finally, it should be explained that the above embodiment is only used to explain the technical scheme of the present disclosure rather than restrict it, although the present disclosure is described in detail with reference to the better embodiment, the ordinary technical personnel in this field should understand that they can still modify or replace the technical scheme of the present disclosure, and these modifications or equivalent substitutions cannot make the modified technical scheme out of the spirit and scope of the technical scheme of the present disclosure.

What is claimed is:

1. A particle tracking method for coral particles in soil based on a multimodal model, comprising the following steps:
S1, conducting a triaxial test using a transparent rubber triaxial membrane;
S2, shooting layers of coral soil particles in real time by two cameras and saving the images taken;
S3, obtaining a three-dimensional cloud image of surface particles by three-dimensional reconstruction of the images taken in S2 through a binocular vision algorithm;
S4, expanding a side of the triaxial specimen taken in S2 into a plane by a bilinear interpolation method;
S5, improving a small sample counting model;
S6, counting the coral soil particles in the image by using an improved small sample counting model, and outputting the position of each target;
S7, inputting the image in S6 into a segmentation model, segmenting the coral soil particles, and obtaining a segmentation result of the coral soil particles;
S8, according to the segmentation results of coral soil particles in S7, obtaining contour coordinates of the coral soil particles, and calculating an aspect ratio, convexity, sphericity, roundness, and Feret diameter of coral soil particles according to the contour coordinates;
S9, inputting multiple images processed in S4 into an optimized BoT-SORT algorithm, and then performing a multi-target tracking, and adding a crushing matching mechanism in a multi-target tracking process;
S10, inputting the tracking results in S9 into the three-dimensional cloud map of S3, and obtaining a three-dimensional motion trajectory of the surface coral soil particles during the test.

2. The particle tracking method for coral particles in soil based on the multimodal model according to claim 1, wherein in S3, the binocular vision algorithm is divided into four steps: camera calibration, image correction, feature matching, disparity smoothing, and post-processing.

3. The particle tracking method for coral particles in soil based on the multimodal model according to claim 2, wherein the camera calibration obtains internal parameters of each camera and external parameters between the cameras through Zhang's calibration method, and converts image coordinates to a same scale and reference frame to ensure an accuracy of subsequent matching calculations; wherein image correction is to project two images onto a plane so that the corresponding points of each scene point overlap on a horizontal line; feature matching uses a global matching algorithm to match corresponding pixels of the physical scene points in left and right images, and performs a disparity estimation; and disparity smoothing and post-processing uses filtering and smoothing algorithms for post-processing to solve a problem of noise and discontinuity in disparity maps and improve a continuity and edge retention of disparity maps.

4. The particle tracking method for coral particles in soil based on the multimodal model according to claim 1, wherein in S4, the bilinear interpolation method is based on information of four nearest pixels to be estimated, wherein the four nearest pixels are in the upper left, the upper right, the lower left, and the lower right positions; and wherein a weighted average is performed according to relative distances between pixels and the target point, thereby achieving a smooth transition that converts the captured surface information into planar data.

5. The particle tracking method for coral particles in soil based on the multimodal model according to claim 1, wherein in S5, the improvement of the small sample counting model is to introduce a self-attention mechanism and a feature enhancement module into the model to enhance a mutual relationship between different spatial locations.

6. The particle tracking method for coral particles in soil based on the multimodal model according to claim 1, wherein in S6, a position of each target refers to a center point coordinate of each coral soil particle.

7. The particle tracking method for coral particles in soil based on the multimodal model according to claim 1, wherein in S7, the segmentation model uses Segment Anything Model; the center point coordinates of the coral soil particles are used as point prompt, and the “coral soil particles” are input into the segmentation model as text prompt to segment the image, and wherein the segmentation result of the coral soil particles refers to the contour coordinates of the coral soil particles.

8. The particle tracking method for coral particles in soil based on the multimodal model according to claim 1, wherein in S9, BoT-SORT optimization refers to adding convexity, sphericity, roundness, and Feret diameter to the Kalman filter of BoT-SORT.

9. The particle tracking method for coral particles in soil based on the multimodal model according to claim 1, wherein in S9, the crushing matching mechanism refers to using Harris corner detection to extract the feature points in the image, and then matching the feature points through Fast Library for Approximate Nearest Neighbors to realize a crushing matching between the original particles and the broken particles; wherein, after the matching between the original particles and the broken particles, the broken particles will inherit the identity of the original particles, and a dimension based on an original identity is added, wherein the identity of the broken particles will increase by one dimension, thus achieving the purpose of traceability.

10. The particle tracking method for coral particles in soil based on the multimodal model according to claim 1, wherein in S10, displacement and breakage of soil particles in coral are obtained by combining the two-dimensional plane tracking information with the particle information in the three-dimensional cloud image.
